(19) United States
(12) Patent Application Publication
(10) Pub. No.: US 2011/0281248 A1
(43) Pub. Date: Nov. 17, 2011

(54) Practice Manager

(75) Inventors: Mark Feenstra, Auckland (NZ); Alden Gannon, Seattle, WA (US)

(73) Assignee: Aliveware Limited, Opaheke, Papakura (NZ)

(21) Appl. No.: 12/989,216

(22) PCT Filed: Apr. 22, 2009
(86) PCT No.: PCT/NZ09/00061

§ 371 Date: Feb. 9, 2011

Related U.S. Application Data
(60) Provisional application No. 61/046,810, filed on Apr. 22, 2008.

(30) Foreign Application Priority Data
Apr. 22, 2008 (CA) 2929602

(51) Int. Cl. G09B 19/00

(52) U.S. Cl. 434/247

(57) ABSTRACT

The present invention relates to a method, software and/or tool for assisting users in meeting a goal. Each time an activity is undertaken, the user logs this occurrence. The method comprises determining the number of times the activity is undertaken in the cycle time period, and an indicator 100 updated to reflect whether the user is on track to achieving their goal.

### FIELD OF THE INVENTION

The present invention relates to a method and/or software tool for assisting a user to achieve goals.

### BACKGROUND TO THE INVENTION

A large number of resources are available to assist people in achieving personal improvement. Typically, personal improvement involves setting a goal. Typical goals might be, for example, to improve fitness, learn a new skill, lose weight or the like. After setting a goal, the person then defines a regime that needs to be completed in order to achieve that goal. The regime consists of completing an activity one or more times, typically in a fixed time period.

A key component in meeting a goal is to ensure that regular practice (completion) of the activity is undertaken. If the person in question regularly carries out the required activities, they are more likely to achieve the end goal. The difficulty for many people is doing the regular practice. It is all too easy to miss regular practice for a variety of reasons, or to lapse into old habits.

Reminder systems are available to assist people with regularly completing their activity to meet their goal. However, many of these are merely reactive indicators of progress to date. They do not promote regular practice.

### SUMMARY OF INVENTION

It is an object of the present invention to assist a person to regularly carry out the activity required to meet or achieve a goal.

In one aspect the present invention may be said to consist in a method for assisting a user to achieve goals comprising the steps of: receiving input from a user defining a goal they wish to achieve, the goal comprising a quantity of an activity to be completed during a cycle, the cycle having a time period, receiving input indicating the completion of the activity on one or more occasions, displaying an indicator, the indicator being updateable to advise the user whether they are currently achieving their goal, wherein the indicator is updated by: determining the number of occasions that the activity has been completed in the time period ending at the updating of the indicator, and visually changing the indicator based on the number of occasions that the activity has been completed in the time period in relation to the quantity of the activity to be completed during the cycle defined for the goal.

Preferably the indicator is visually changed to advise the user whether they are currently achieving their goal to indicate that: the user has completed a required quantity of the activity in the time period, or the user has not completed the required quantity of the activity in the time period.

Preferably the required quantity of activity is determined as being at least the quantity of the activity to be completed during a cycle defined for the goal.

Preferably the required quantity of activity is determined as being at most the quantity of the activity to be completed during a cycle defined for the goal.

Preferably the required quantity of activity is determined as being a range of quantities either side of the quantity of the activity to be completed during a cycle defined for the goal.

Preferably the indicator comprises an icon that is updated by visually changing the icon to: a first colour when the user is determined as are currently achieving their goal, and a second colour when the user is determined as not are currently achieving their goal.

Preferably the indicator is visually changed to advise the user whether they are currently achieving their goal to indicate that the user has not completed the required quantity of the activity in the time period, the indicator can be changed to one of two states, wherein a first state indicates that the user is not currently achieving their goal by a first margin, or a second state indicates that the user is not currently achieving their goal by a second margin.

Preferably the number of practices over the past cycle period is less than a weighting times the quantity defined for the goal, then the indicator is in a first state indicating non-compliance with the goal, and if the number of practices over the past cycle period is greater than or equal to the quantity defined for the goal, then the indicator is in a second state indicating compliance with the goal.

Preferably the number of practices over the past cycle period is less than a weighting times the quantity defined for the goal, then the indicator is in a first state indicating compliance with the goal, and if the number of practices over the past cycle period is greater than or equal to the quantity defined for the goal, then the indicator is in a second state indicating non-compliance with the goal.

Preferably the number of practices over the past cycle period is equal to the quantity defined for the goal (within a tolerance), then the indicator is in a first state indicating compliance with the goal, and if the number of practices over the past cycle period is not equal to the quantity defined for the goal (within a tolerance), then the indicator is in a second state indicating non-compliance with the goal.

Preferably the total sum of targets for the past cycle is greater than or equal to the practice quantity defined for the goal multiplied by the target, then the indicator is in a first state indicating compliance with the goal, and if the total sum of targets for the past cycle is greater than or equal to a weighting times the practice quantity defined for the goal multiplied by the target, then the indicator is in a second state indicating non-compliance with the goal.

Preferably the total sum of targets for the past cycle is less than the practice quantity defined for the goal multiplied by the target, then the indicator is in a first state indicating compliance with the goal, and if the total sum of targets for the past cycle is less than or equal to a weighting times the practice quantity defined for the goal multiplied by the target, then the indicator is in a second state indicating non-compliance with the goal.

Preferably the total sum of targets for the past cycle is equal to the practice quantity defined for the goal multiplied by the target, then the indicator is in a first state indicating compliance with the goal, and if the total sum of targets for the past cycle is not equal to the practice quantity defined for the goal multiplied by the target, then the indicator is in a second state indicating non-compliance with the goal.

In another aspect the present invention may be said to consist in a system for assisting a user to achieve goals comprising a computer system accessible by end users over a network, the computer system adapted to: receive input from a user defining a goal they wish to achieve, the goal comprising a quantity of an activity to be completed during a cycle, the cycle having a time period,
receive input indicating the completion of the activity on one or more occasions, display an indicator, the indicator being updateable to advise the user whether they are currently achieving their goal, wherein the indicator is updated by: determining the number of occasions that the activity has been completed in the time period ending at the updating of the indicator, and visually changing the indicator based on the number of occasions that the activity has been completed in the time period in relation to the quantity of the activity to be completed during the cycle defined for the goal.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF LIST OF THE DRAWINGS

Preferred embodiments of the invention will be described with reference to the following drawings, of which:

FIG. 1 is a flow diagram of the steps undertaken by a user in using a practice manager tool according to an embodiment of the invention,

FIG. 2 is a flow diagram of a method carried out by a practice manager tool according to one embodiment of the invention,

FIG. 3 is a block diagram of a system for implementing the tool,

FIG. 4 is a screen shot of a summary page of the practice manager tool,

FIG. 5 is a screen shot of a goal entry screen of the tool,

FIG. 6 is a screen shot of a goal entry screen of the tool with information entered,

FIG. 7 is a screen shot of an updated summary page with the new goal,

FIG. 8 is a screen shot of a practice summary page with no practices logged,

FIG. 9 is a screen shot of a practice summary page with one practice logged,

FIG. 10 is a screen shot of a practice summary page with one practice logged,

FIG. 11 is a screen shot of a practice summary page with two practices logged on a later day,

FIG. 12 is a screen shot of a practice summary page with three practices logged,

FIG. 13 is a screen shot of a summary page for another defined goal,

FIG. 14 is a summary page for another defined goal.

### DETAILED DESCRIPTION OF PREFERRED EMBODIMENTS

The present invention relates to a method and/or software for assisting users to meet their goals, generally called a “practice manager”. The software can take the form of a software tool. The invention can be used on its own or as part of an overall support system for assisting users in meeting their goals. For example, the invention might be provided as part of a website that assists users to obtain information on meeting goals and provides community support in the form of discussion pages.

In a preferred embodiment, the method and/or tool provides visual indications of whether or not the user is on schedule to meeting their goal through regular practice of the necessary activity. The tool provides inputs for: defining the goals, defusing activity(ies) for meeting that goal, and logging practices. However, it will be appreciated that the invention could take other forms.

Overview

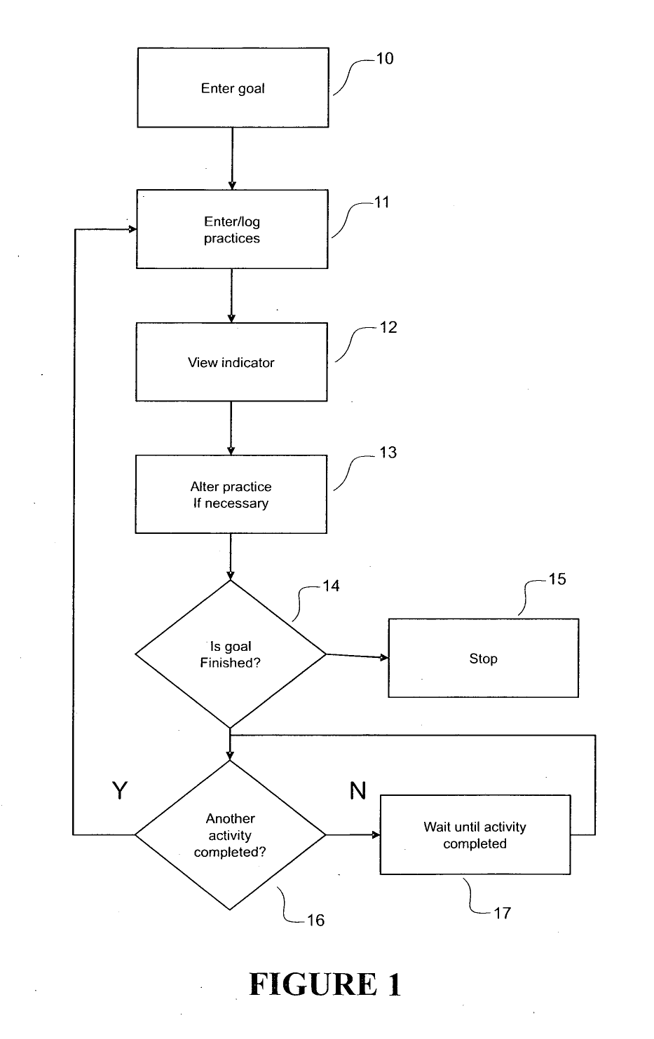

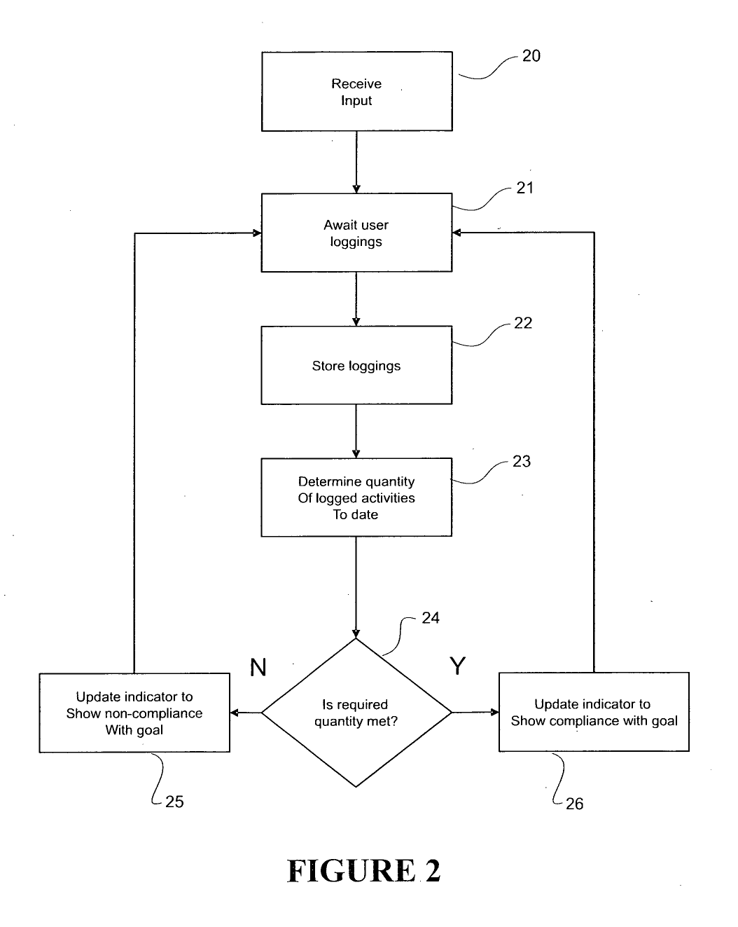

A general description of a preferred embodiment of the invention will be described with reference to FIGS. 1 and 2. FIG. 1 shows the actions undertaken by a user in using a tool according to the invention to receive feedback on whether or not they are on schedule to meet their goals. FIG. 2 shows the method carried out by a software tool for providing that information.

Referring to FIG. 1, the user enters information defining their goal into the tool using a user interface, step 10. The goal might have a description indicating what the purpose/end result of the goal is—such as improving fitness. The user then specifies a regime or practice for meeting the goal. This is done by specifying an activity that must be carried out a certain quantity of times over a cycle in order to achieve that goal. The cycle will have a time period or length associated with it. For example, the user might decide that to improve fitness that they have to go for three jogs per week. In this goal, the “goal” is improving fitness, the “jog” is the activity, “three” is the quantity of the activity that must be carried out per cycle, “per week” is the cycle, and the time period for the cycle is “one week”. In this context an activity can be any action that needs to be undertaken as part of a regime to work towards achieving the goal. The user can define the cycle and time period, along with the required activity and quantity. Depending on the nature of the practice, the user will alter the cycle and time period that is suitable to provide improvement. For example, the user could choose 3 jogs per week, or alternatively 12 jogs per month. 12 jogs per month will provide more flexibility in when the practice is done (for example it could be bunched at the beginning or end), whereas 3 jogs per week provides less flexibility. Choosing a lesser time period for the cycle can be more advantageous as it promotes more regular (less “bunched”) practice.

This goal could be considered an “at least” goal, being a goal where the user must complete the activity at least the number of times defined by the quantity within the time period of the cycle. Alternatively, an “at most” goal could be defined. This is where the user has a regime or practice where they should not carry out or complete the activity more than the specified quantity of times defined for the cycle time period. An example of this would be where a person is trying to cut down smoking. To achieve their goal, they might specify smoking five cigarettes per day. This means that they should smoke at most five cigarettes in any one day. Another type of goal might require that the person should try as much as possible to do exactly the quantity of the activity per time period. For example, to improve eating habits a person may have specified the regime or practice of eating three times per day. Eating more than three times per day, or less than three times per day would be considered undesirable and doing either would not meet the goal.

Once the goal has been defined, the person can then log each time that they complete an activity that forms part of the goal's regime, step 11. The user can enter information to log completion of an activity via a user interface. The logging of an activity may simply be a matter of indicating that an activity has been completed on/at a certain day or time. Optionally, in addition the user may log comments in relation to the completion of the activity and/or give themselves a rating for that activity. Optionally, the user may further have the opportunity to answer one or more standard questions in relation to their practice. Answering such questions might optionally be a significant component of performing the practice in question. Answering these questions also serves to indicate that the user has performed the practice on that occasion.

The tool will then update the indicator to advise the person how their practice is going. In effect, the indicator will indicate to the person as at the time it is updated whether or not the person is currently on track to meet their goal. That is, if now (the point of doing the update) was considered the end of a cycle, would the person have completed the required quantity of activity defined for the goal for that cycle time period.

When the person has viewed, step 12, their updated status of progress, they can then alter their practice accordingly, step 13. If they have not completed the required quantity of activity, then they know they need to alter their practice habits to rectify this.

If the practice has a fixed lifetime, and that lifetime is reached, then the process stops, steps 14, 15. Otherwise, the person continues with their practice as and when they can, step 17. If they complete another activity as part of their practice, step 16, then they go back and continue the method by entering or logging their practice, viewing the updated status and altering their practice based on this if necessary.

FIG. 2 shows the method carried out by the software tool that assists the user. First, the tool receives input from the user for defining their goal, step 20. This will include an activity description, a quantity or number of times the activity should be conducted or completed for the goal's regime, and a cycle (and cycle length) over which the quantity of activity should be done.

The tool then awaits for input from the user as and when they complete an activity, step 21. When the tool receives input, for example in the form of a check box, it then records that the activity has been completed, the date it has been completed and any other relevant information such as narrative or rating, step 22.

The tool then determines if the indicator needs to be updated to indicate a different status of the person's current adherence to the goal's regime. To do so, the tool determines the quantity of all times that the activity has been completed by the person in a cycle (step 23)—where the cycle is considered to have finished at the point in time of doing the update. For example, if the goal is to jog three times per week, the tool would determine how many runs had been completed by the user in the past week taken from today extending back for a week. In effect, the tool determines if the quantity of activity completed in the last cycle length meets the required quantity of activity to be completed. The tool effectively considers that the time of update is the end of a cycle period.

In the case of a goal that is an “at least” type goal, the required quantity of the activity will be that the person has completed at least the quantity of activity defined by the goal for a cycle. If the goal is an “at most” type goal, the required quantity of the activity to be completed will be at most the quantity of the activity defined for the goal for a cycle. If the type of goal is an “exactly” type goal, then the required quantity of activity to be completed must match the quantity defined for the goal. A match might not be an exact match, but a match to within defined tolerances.

If the person has completed the required quantity of activity for that time period, step 24, then the tool will update an indicator display to show that the person is on track for their goal, namely they are currently meeting their goal, step 26. This means that if today were considered the end of the cycle, they would have met their goal. Conversely, if the person has not completed the required quantity of the activity, then the tool will update the indicator to display visually an indicator telling the user they are not meeting their goal at this point in time, step 25. That is, if their goal cycle stopped today, they would not have met their goal. Therefore, the cycle is not fixed to particular days (such as Sunday to Sunday) but is a moving time period or “window” that is considered to stop at the time of indicator update, and extends backwards in time for the length defined for the cycle.

In a possible embodiment, the indicator could take the form of lights such as green lights and red lights. Where the person is currently meeting their goal, the tool will display a green light. Conversely, if the person not currently meeting their goal, then a red light will be displayed. Optionally green, yellow (or orange) and red light indicators could be used. Green would be used in the manner as disclosed above. Where a person is not meeting their goal, two levels of indicator could be provided. The first is where they are significantly short of meeting their goal, in which case a red light indicator would be shown. This indicates that serious improvement is required. Alternatively, where the person is not so deficient in meeting their goal, but still has not done so, a yellow (or orange) light could be displayed—this indicates that some improvement is required.

Clearly, any number of levels of indicator could be shown the above being an example only. Further, different types of visual or audio indicators could be provided. The green/yellow(orange)/red indicators described above are one example only. What the indicator does do is provides information to the user indicating whether or not at this current point in time they are meeting their goal. This rewards more consistent practice, as the user can get a snapshot now of how they are doing. It is not necessary to wait until the end of a cycle at a fixed point in time to determine whether the goal will be met. Each day (or other update time) the user can get immediate feed back on how they are doing. If they are not currently meeting their goal, they know that immediate action is required.

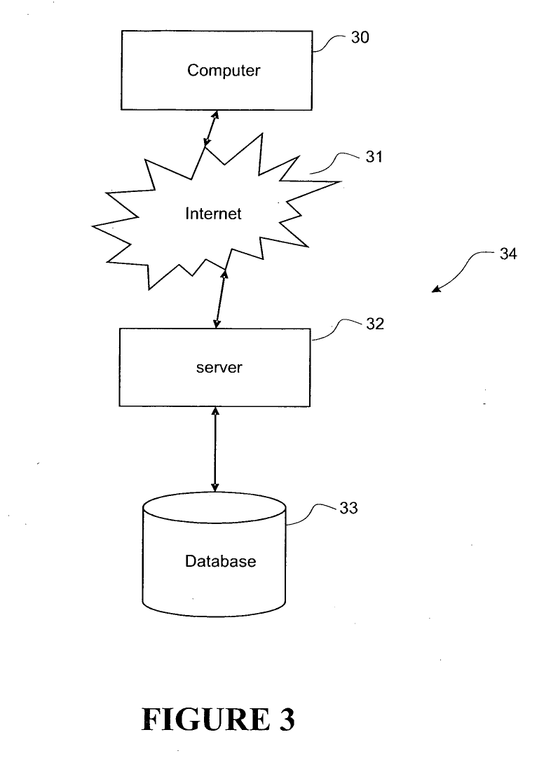

FIG. 3 shows a hardware system 34 that the tool may operate on. In a preferred embodiment, the tool is provided in a website or interface that can be accessed by a user. The user would have a computer terminal 30 or the like that is connected to the internet 31 or other wide area network. The software tool would run on a server 32 that is also connected to the internet. The server might be connected also to a database 33 for storage of information. When the user wishes to use the tool either directly or as part of an overall self help computer resource, they would enter their password and access the tool via their terminal 30. The terminal would communicate with the server 32 via the internet 31 to input the various information received from the user via the computer. The server executing the tool would run the software for carrying out the various user interfaces and algorithms. After receiving input, the software would implement an algorithm to determine the status of the user's current practice based on user logs, and then would determine what indicator state needed to be displayed. The server would then provide data over the internet to be received by the user's computer. The user computer would use this data to render a screen that includes an indicator visually providing the status determined.

### Detailed Example of Preferred Embodiment

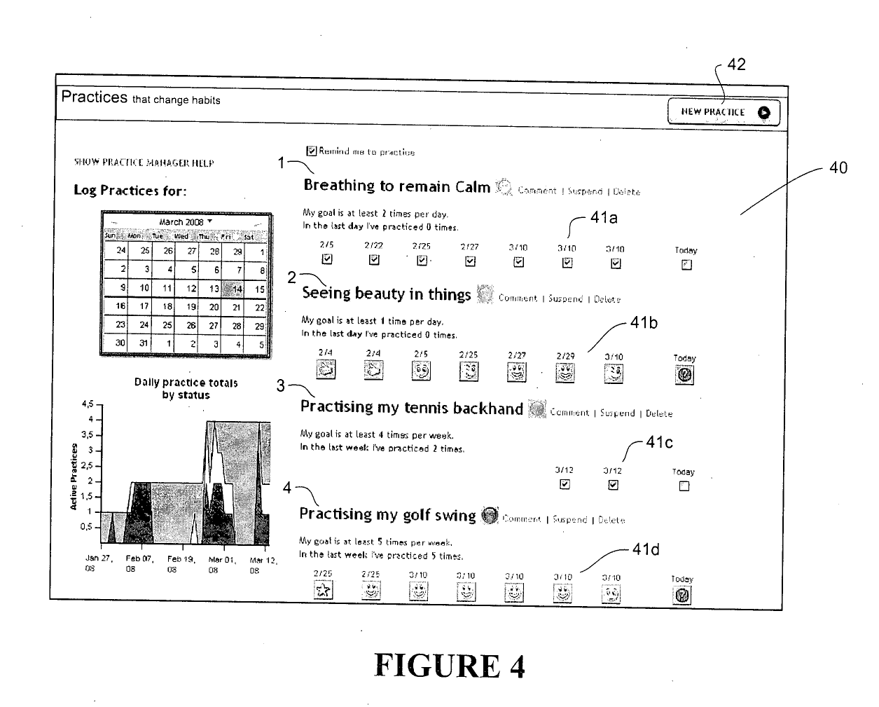

A more detailed explanation of the preferred embodiment will now be described with reference to FIGS. 4 to 11. These Figures show screen shots of a practice manager, illustrating a particular goal being defined and the logging of activities completed.

FIG. 4 shows a summary screen 40 of a practice manager software tool indicating various goals that have been defined for this particular person. As can be seen, the user already has four goals defined. These are:
1) breathing to remain calm,
2) seeing beauty in things,
3) practising my tennis back hand,
4) practising my golf swing.

Further, for each of these a number of activity completions have been logged 41a-43a. The date of the activity completion in each case is indicated, along with a rating in some cases. This will be described further later.

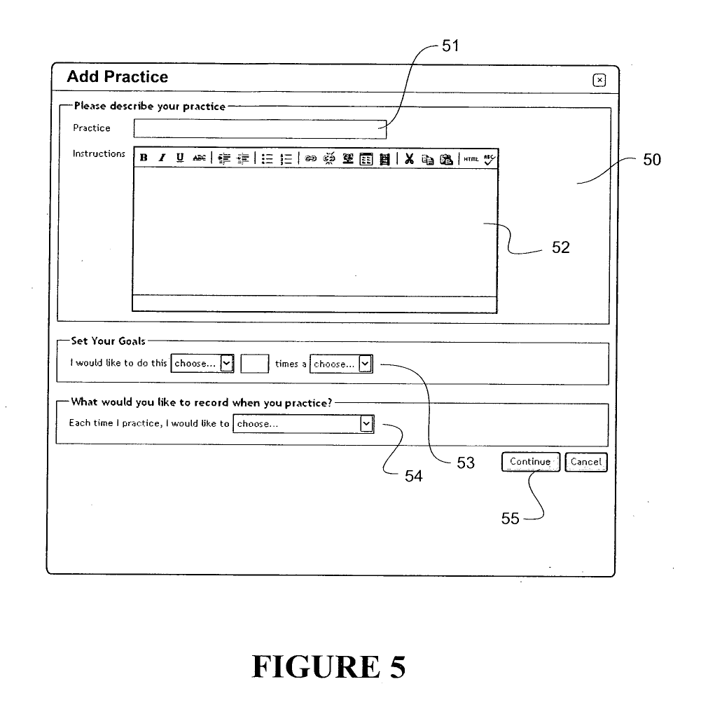

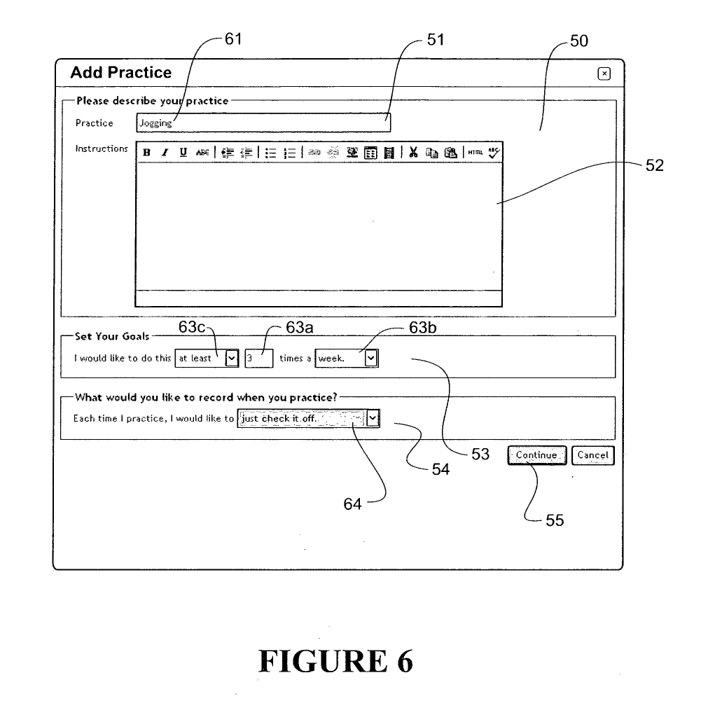

If a user wants to create a new goal, they click the “new practice” icon 42 in the top right hand of the screen. This then opens a new screen 50 as shown in FIG. 5, which allows the user to enter details to define the goal. Referring to FIG. 6, a particular goal has been defined. The goal is to improve fitness, and the defined regime to meet that goal is to jog at least three times a week. Therefore, in the practice field (also known as the activity field) 50 the word “jogging” 61 has been entered. Instructions for the practice can also be entered, in the instructions field 52, if desired. The user then enters the quantity 63a of the activity that they want to complete for each cycle. In this case the quantity is “3”. They then enter the cycle/time period. In this case it is “one week” 63b.

In addition, the user can define the type of goal this is, being one of “at least”, “at most” or “exactly”. In this case, the goal type is an “at least type” 63c, because the user wants to complete at least three jogs a week. Completing more than three jogs a week is advantageous, and therefore it is not a problem if the quantity of activity is exceeded in the cycle. Finally, the user can decide how they will log completion of an activity. For example, as shown they can check it off 64, meaning they simply indicate when the activity is complete. Alternatively, in addition they could provide a narrative relating to completion of their activity. Further, they may provide an “emoticon” to visually indicate how they felt their practice went. Optionally, the user may further have the opportunity to answer one or more standard questions in relation to their practice.

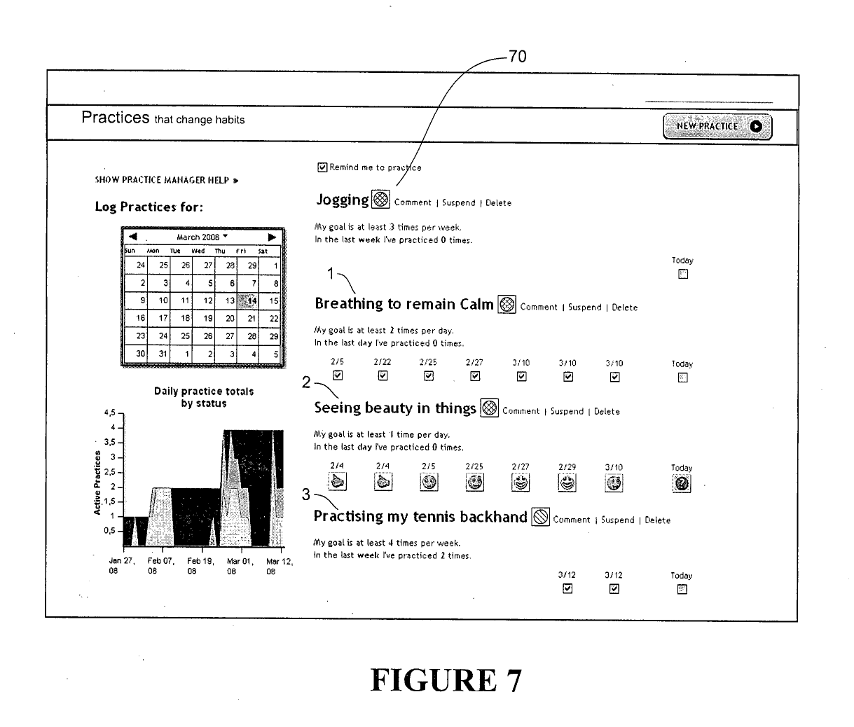

Once the parameters for the goal have been entered, the continue button 55 is pressed and the goal is defined. Referring to FIG. 7, it can now be seen that the goal 70 is displayed on the practice summary screen in addition to the previously defined goals 1-4.

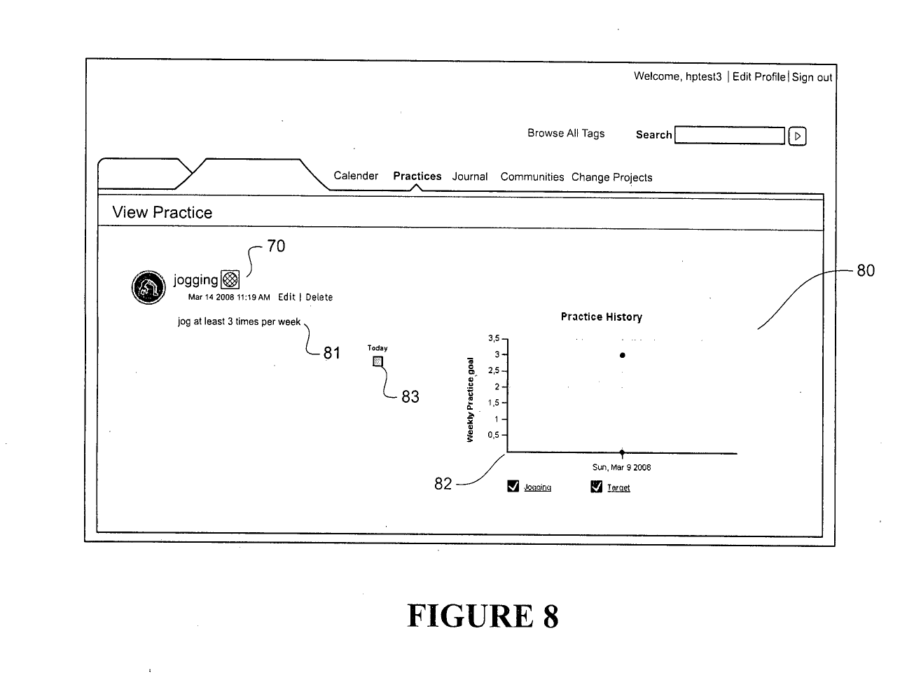

The user then sets out trying to complete the regime defined for the goal, by completing the activity the required quantity of times during a cycle. Each time the user goes for a jog, they log this occurrence or occasion in the tool. FIG. 8 shows a logging screen 80. It displays the definition of the goal 81, and a graph showing a practice history 82. The practice history shows the number of times an activity is completed for each of the days in the history of the regime practice. In this early case, no completions have been logged. The practice logging screen also comprises a check box labelled “today” 83, where a user can check if they have actually completed the defined activity today.

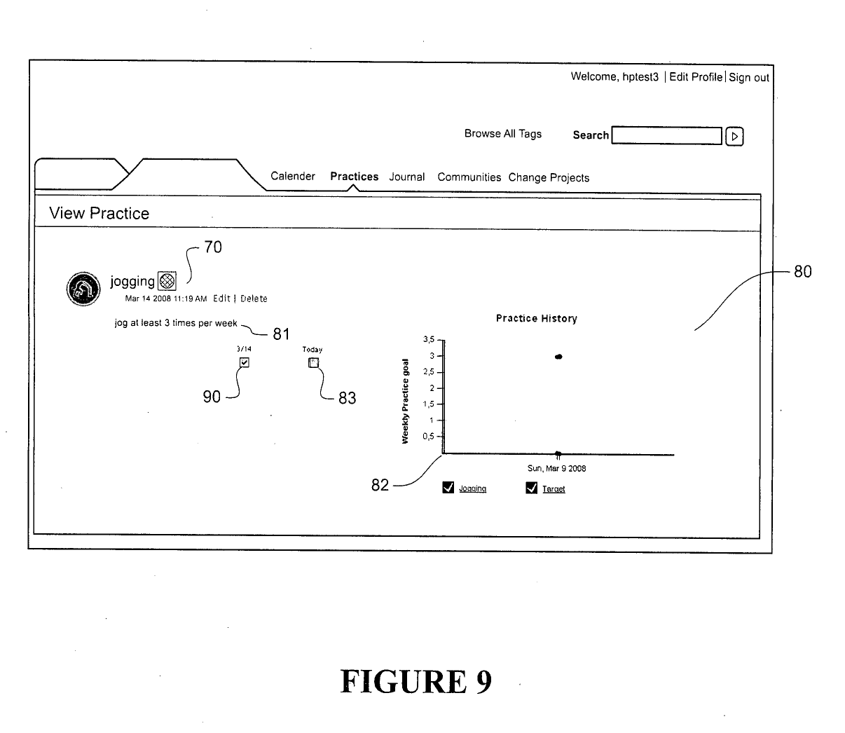

Referring to FIG. 9, in this case the user has been for a jog on the 14 Mar. 2008, and therefore they have ticked the “today” box. The box then changes to the current date 90 and a further today box 83 is set ready for further practice, should it take place.

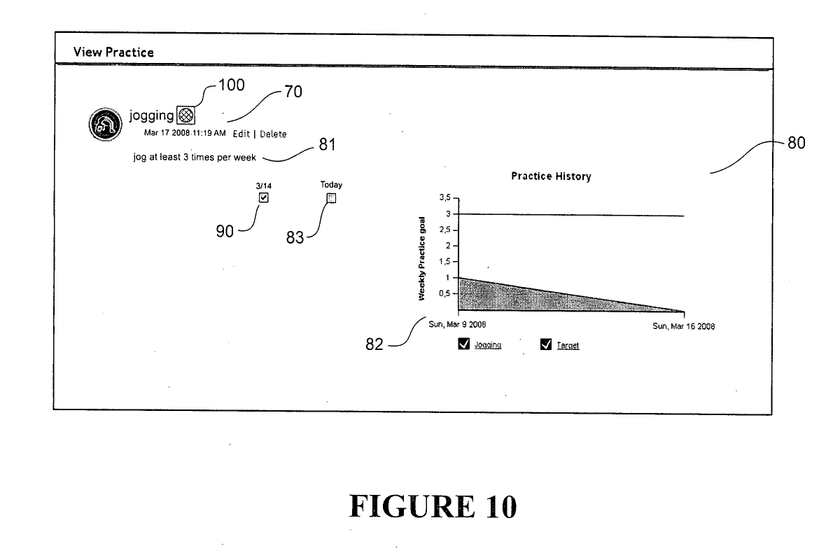

Several days later, a user can revisit the page as shown in FIG. 10—the date being 17 Mar. 2008. Here a practice history graph 82 is shown, with a period from Sunday March 9 to Sunday March 16 shown. The single jogging completion logged on 14 March 90 is indicated. The page also shows an indicator 100, which in this case is red. Because the user has only completed one jog in the last week (being the cycle period), as at this point in time, they are not meeting the required practice of 3 jogs per week. Had the user logged three jogs in the past week, from today, the indicator 100 would be green.

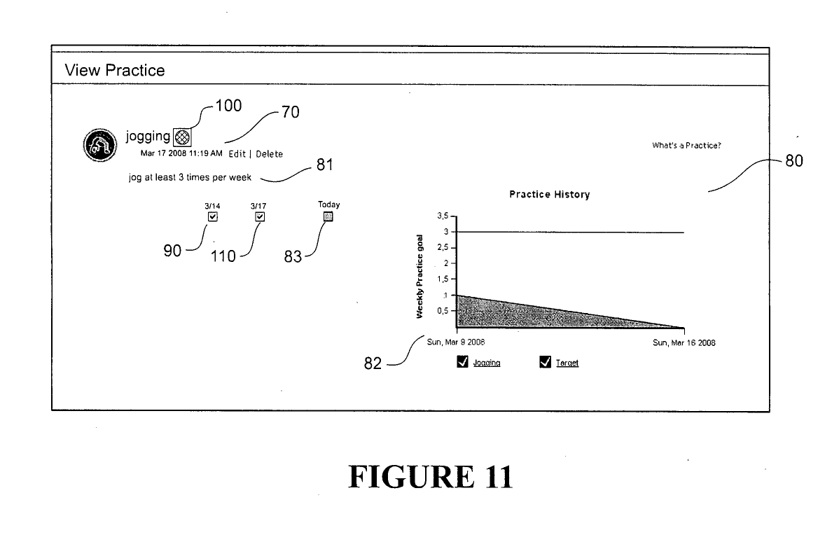

Also indicated is another “Today” box 83, which can be checked if the user has completed another. Referring to FIG. 11, shows what happens if the user goes for another jog. They click the “today” 83 box and the page is refreshed to show a box 110 with a tick for 17 March—being the day of completing the second jog. Now the indicator is updated at the time of page refresh. The software determines how many jogs have been completed in the past week taken from today (17 Mar. 2008). As only two jogs have been completed, the user has not completed the required number of jogs per week for this goal—namely 3. Therefore, a red indicator 100 is still shown. This indicates that the user is not currently meeting their goal.

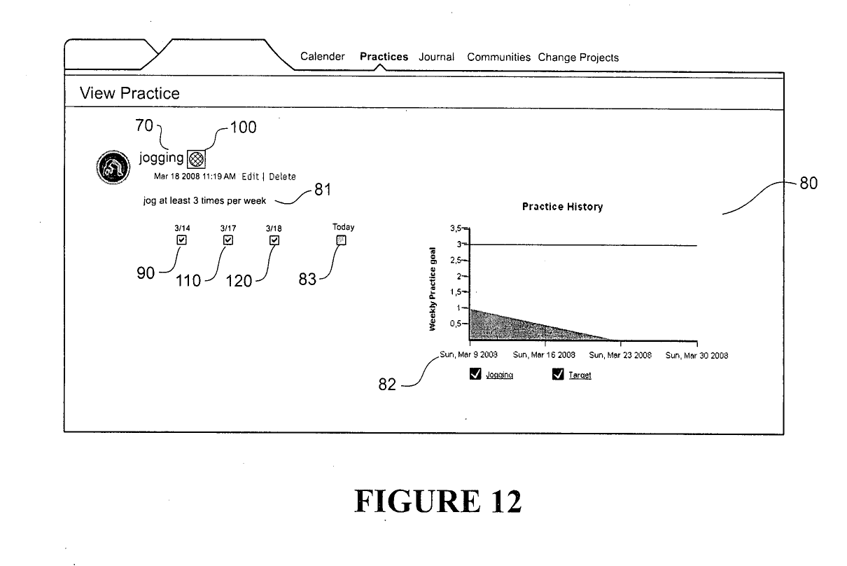

FIG. 12 shows what happens if the user goes for another jog on 18 March. They click the “today” box and the page is refreshed to show a box with a tick 120 for 18 March—being the day of completing the third jog. Now the indicator is updated at the time of page refresh. The software determines how many jogs have been completed in the past week taken from today (17 Mar. 2008). Three jogs have been completed, therefore the user has completed the required number of jogs per week for this goal 70—namely 3. The indicator 100 is updated to show a green indicator. This indicates that the user is currently meeting their goal. However, if the user does not log any more runs for several days, the indicator will revert back to red, if at that point three jogs have not been completed in the last week.

It is possible for a yellow indicator to be shown also. This can occur where practice is not meeting the required quantity, but is above a certain level. For example, if the current status is 2 jogs for the past week, a yellow indicator might be displayed instead of a red indicator.

One possible algorithm for determining how to update the indicator is set out below in pseudo-code. The progress indicator needs to take into account the require quantity of activity completions logged for the past cycle. A red indicator has value 1, a yellow indicator value 2 and green value 3.

For an “at least” frequency type:

if (the number of practices logged in period (Now—Practice Cycle)<0.5*frequency target) then frequency is red.

else if (the number of practices logged in period (Now—Practice Cycle)>=frequency target) then frequency is green.

else frequency is yellow.

Where “now” is the current time,
“practice cycle” is the length of the cycle,
“Frequency target” is the quantity of activity completions required per cycle.

In summary, if the number of practices over the past cycle period is less than half the quantity defined for the goal, then the indicator is red. If the number of practices over the past cycle period is greater than or equal to the quantity defined for the goal, then the indicator is green. Otherwise the indicator is yellow

For an “at most” frequency type:

if (the number of practices logged in period (Now—Practice Cycle)>1.5*frequency target) then frequency is red.

else if (the number of practices logged in period (Now—Practice Cycle)>frequency target) then frequency is yellow.

else frequency is green.

In summary, if the number of practices over the past cycle period is less than the quantity defined for the goal, then the indicator is green. If the number of practices over the past cycle period is greater than 150% of the quantity defined for the goal, then the indicator is red. Otherwise the indicator is yellow

For an “exactly” frequency type:

if (0.8*(frequency target)<the number of practices logged in period (Now—Practice Cycle)<=(frequency target)*1.2) then frequency is green.

else if (0.5*(frequency target)<(the number of practices logged in period (Now—Practice Cycle)<=(frequency target)*1.5) then frequency is yellow,

else then frequency is red.

In summary, if the number of practices over the past cycle period is within plus or minus 20% of the quantity defined for the goal, then the indicator is green. If the number of practices over the past cycle period is within plus or minus 50% of the quantity defined for the goal, then not equal to the quantity defined for the goal, then the indicator is yellow. Otherwise, the indicator is red. Clearly, this is just one set of tolerances for a match and the tolerance for a match could be adjusted as required. An exact match could be defined, if desired.

The tool can also allow a user to record a number for every practice event. That number can have a goal too. For example, the goal might be to jog 3 miles per day, 5 days per week. This is a two part goal, which are treated separately. The tool tracks the goal “jog at least 3 miles when I jog” separately from “jog at least 5 times per week”. So, if you jog 8 miles twice a week to meet the total distance goal, the indicator will still register non-compliance, as you have not run 5 times in that week.

Where a numeric type is required for the goal (such as run 3 miles per day), another algorithm is used to determine if the total number (such as miles per week) is met for the cycle. This algorithm is set out below.

For an “at least” target type:

if (SUM(all targets logged in period (now—practice cycle))>=target*(the number of practices logged in period (Now—Practice Cycle)) then target is green.

else if (SUM(all targets logged in period (now—practice cycle))>=0.5*target*(the number of practices logged in period (Now—Practice Cycle)) then target is yellow.

else target is red.

Where “now” is the current time,
“practice cycle” is the length of the cycle,
“Frequency target” is the quantity of activity completions required per cycle.
“target” is the target value per activity (such as 3 miles).

In summary, if the total sum of targets for the past cycle is greater than or equal to the practice quantity defined for the goal multiplied by the target, then the indicator is green. If the total sum of targets for the past cycle is greater than or equal to half the practice quantity defined for the goal multiplied by the target, then the indicator is yellow. Otherwise the indicator is red.

For an “at most” type:

if (SUM(all targets logged in period (now—practice cycle))<target*(the number of practices logged in period (Now—Practice Cycle)) then target is green.

else if (SUM(all targets logged in period (now—practice cycle))<=1.5*target*(the number of practices logged in period (Now—Practice Cycle)) then target is yellow.

else target is red.

In summary, if the total sum of targets for the past cycle is less than the practice quantity defined for the goal multiplied by the target, then the indicator is green. If the total sum of targets for the past cycle is less than or equal to the practice quantity defined for the goal multiplied by the one and a half times the target, then the indicator is yellow. Otherwise the indicator is red.

For an “exactly” type:

if (0.8*target*(the number of practices logged in period (Now-Practice Cycle)))<SUM(all targets logged in period (now—practice cycle))<(1.2*target*(the number of practices logged in period (Now—Practice Cycle))) then target is green.

else if (0.5*target*(the number of practices logged in period (Now—Practice Cycle)))<SUM(all targets logged in period (Now—Practice Cycle))<(1.4*target*(the number of practices logged in period (Now—Practice Cycle))) then target is yellow.

Else target is red

In summary, if the total sum of targets for the past cycle is within plus or minus 20% of the practice quantity defined for the goal multiplied by the target, then the indicator is green. If the total sum of targets for the past cycle is within plus or minus 50% of the practice quantity defined for the goal multiplied by the target, then the indicator is yellow. Otherwise the indicator is red.

An algorithm can also be provided for determining the indicator status for the combination of numerical type goals (e.g. run 3 miles per jog) with non-numeric type goals (e.g. run 5 times per week). Using the above algorithms as appropriate, we assume a red has value 1, green value 3 and yellow value 2. A value is determined using the appropriate algorithm above for the numeric and then non-numeric type goal. The average of the two numbers is found, and this rounded to the nearest integer. If the answer is one, the indicator is red. If the answer is two, the indicator is yellow. If the answer is three, the indicator is green.

Clearly other types of algorithm could be devised that still implement the general concept of determining the current state of practice. In particular, different weightings could be used for determining thresholds of compliance. Different tolerances (including an exact match tolerance) could be provided for the “exactly” match target type. The thresholds and tolerances described above are illustrative and by way of example only. Any suitable thresholds/tolerances could be set to determine changes in the indicator from green/yellow/red etc.

It will also be appreciated that inequalities could altered as required. For example, “greater than or equal to”, could be swapped for “greater than” and vice versa.

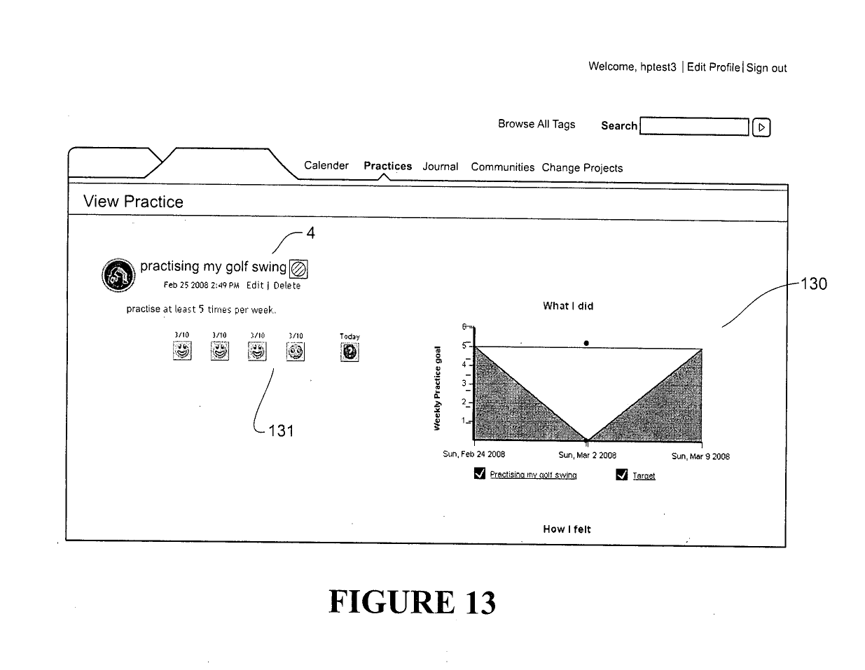

FIG. 13 shows a practice summary page 130 for another goal 4. As can be seen, a number of practices 131 are shown. Emoticons are also shown, indicating how the user felt about their practice. Other types of indicators or icons could be shown to indicate the user's feelings about practice.

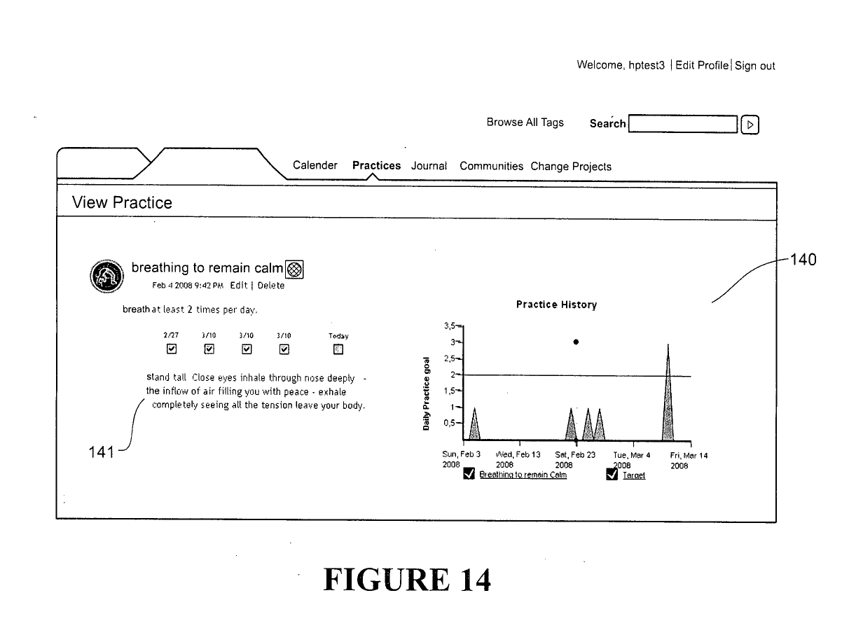

FIG. 14 shows another practice summary page for yet another goal. A narrative for the practice is shown, along with a graph showing occasions of practice.

In FIGS. 13 and 14, the practice history graph shows when activities are actually completed.

What we claim is:

1. A method for assisting a user to achieve goals comprising the steps of:
receiving input from a user defining a goal they wish to achieve, the goal comprising a quantity of an activity to be completed during a cycle, the cycle having a time period,
receiving input indicating the completion of the activity on one or more occasions,
displaying an indicator, the indicator being updateable to advise the user whether they are currently achieving their goal,
wherein the indicator is updated by:
determining the number of occasions that the activity has been completed in the time period ending at the updating of the indicator, and
visually changing the indicator based on the number of occasions that the activity has been completed in the time period in relation to the quantity of the activity to be completed during the cycle defined for the goal.

2. A method for assisting a user to achieve goals according to claim 1 wherein the indicator is visually changed to advise the user whether they are currently achieving their goal to indicate that:
the user has completed a required quantity of the activity in the time period, or
the user has not completed the required quantity of the activity in the time period.

3. A method for assisting a user to achieve goals according to claim 1 wherein the required quantity of activity is determined as being at least the quantity of the activity to be completed during a cycle defined for the goal.

4. A method for assisting a user to achieve goals according to claim 1 wherein the required quantity of activity is determined as being at most the quantity of the activity to be completed during a cycle defined for the goal.

5. A method for assisting a user to achieve goals according to claim 1 wherein the required quantity of activity is determined as being a range of quantities either side of the quantity of the activity to be completed during a cycle defined for the goal.

6. A method for assisting a user to achieve goals according to claim 1 wherein the indicator comprises an icon that is updated by visually changing the icon to:
a first colour when the user is determined as are currently achieving their goal, and
a second colour when the user is determined as not are currently achieving their goal.

7. A method for assisting a user to achieve goals according to claim 1 wherein when the indicator is visually changed to advise the user whether they are currently achieving their goal to indicate that the user has not completed the required quantity of the activity in the time period, the indicator can be changed to one of two states, wherein
a first state indicates that the user is not currently achieving their goal by a first margin, or
a second state indicates that the user is not currently achieving their goal by a second margin.

8. A method for assisting a user to achieve goals according to claim 1 wherein if the number of practices over the past cycle period is less than a weighting times the quantity defined for the goal, then the indicator is in a first state indicating non-compliance with the goal, and if the number of practices over the past cycle period is greater than or equal to the quantity defined for the goal, then the indicator is in a second state indicating compliance with the goal.

9. A method for assisting a user to achieve goals according to claim 7 wherein if the number of practices over the past cycle period is less than a weighting times the quantity defined for the goal, then the indicator is in a first state indicating compliance with the goal, and if the number of practices over the past cycle period is greater than or equal to the quantity defined for the goal, then the indicator is in a second state indicating non-compliance with the goal.

10. A method for assisting a user to achieve goals according to claim 7 wherein if the number of practices over the past cycle period is equal to the quantity defined for the goal (within a tolerance), then the indicator is in a first state indicating compliance with the goal, and if the number of practices over the past cycle period is not equal to the quantity defined for the goal (within a tolerance), then the indicator is in a second state indicating non-compliance with the goal.

11. A method for assisting a user to achieve goals according to claim 7 wherein if the total sum of targets for the past cycle is greater than or equal to the practice quantity defined for the goal multiplied by the target, then the indicator is in a first state indicating compliance with the goal, and if the total sum of targets for the past cycle is greater than or equal to a weighting times the practice quantity defined for the goal multiplied by the target, then the indicator is in a second state indicating non-compliance with the goal.

12. A method for assisting a user to achieve goals according to claim 7 wherein if the total sum of targets for the past cycle is less than the practice quantity defined for the goal multiplied by the target, then the indicator is in a first state indicating compliance with the goal, and if the total sum of targets for the past cycle is less than or equal to a weighting times the practice quantity defined for the goal multiplied by the target, then the indicator is in a second state indicating non-compliance with the goal.

13. A method for assisting a user to achieve goals according to claim 7 wherein if the total sum of targets for the past cycle is equal to the practice quantity defined for the goal multiplied by the target, then the indicator is in a first state indicating compliance with the goal, and if the total sum of targets for the past cycle is not equal to the practice quantity defined for the goal multiplied by the target, then the indicator is in a second state indicating non-compliance with the goal.

14. A system for assisting a user to achieve goals comprising a computer system accessible by end users over a network, the computer system adapted to:
receive input from a user defining a goal they wish to achieve, the goal comprising a quantity of an activity to be completed during a cycle, the cycle having a time period,
receive input indicating the completion of the activity on one or more occasions,
display an indicator, the indicator being updateable to advise the user whether they are currently achieving their goal,
wherein the indicator is updated by:
determining the number of occasions that the activity has been completed in the time period ending at the updating of the indicator, and
visually changing the indicator based on the number of occasions that the activity has been completed in the time period in relation to the quantity of the activity to be completed during the cycle defined for the goal.
